(19) United States
(12) Patent Application Publication
(10) Pub. No.: US 2007/0274897 A1
(43) Pub. Date: Nov. 29, 2007

(54) PROCESSES FOR THE PREPARATION OF CHLORINE BY GAS PHASE OXIDATION

(75) Inventors: Aurel Wolf, Wulfrath (DE); Leslaw Mleczko, Dormagen (DE); Oliver Felix-Karl Schluter, Leverkusen (DE); Stephan Schubert, Leverkusen (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,403

(22) Filed: May 23, 2007

(30) Foreign Application Priority Data
May 23, 2006 (DE) 102006024545.8
Apr. 26, 2007 (DE) 102007020154.2

(51) Int. Cl. C01B 7/04; B01J 27/06; B01J 27/135; B01J 27/13; C01B 7/00

(52) U.S. Cl. 423/502; 502/224; 502/227; 502/230

(57) ABSTRACT

Processes for the preparation of chlorine by catalytic gas phase oxidation of hydrogen chloride with oxygen, wherein the catalyst comprises tin dioxide and at least one halogen-containing ruthenium compound, and such catalysts comprising at least one halogen-containing ruthenium compound and a tin dioxide support material are disclosed along with the use thereof.

### BACKGROUND OF THE INVENTION

The process, developed by Deacon in 1868, of catalytic oxidation of hydrogen chloride with oxygen in an exothermic equilibrium reaction was at the beginning of industrial chlorine chemistry:
4 HCl+O₂ [symbol] 2 Cl₂+2 H₂O

However, the Deacon process was pushed severely into the background by chlor-alkali electrolysis. Virtually the entire production of chlorine was by electrolysis of aqueous sodium chloride solutions (Ullmann Encyclopedia of Industrial Chemistry, seventh release, 2006). However, the attractiveness of the Deacon process has recently been increasing again, since worldwide demand for chlorine is growing faster than the demand for sodium hydroxide solution. The process for the preparation of chlorine by oxidation of hydrogen chloride, which is unconnected with the preparation of sodium hydroxide solution, satisfies this development. Furthermore, hydrogen chloride is obtained as a linked product in large quantities, for example, in phosgenation reactions, as in the preparation of isocyanate.

The oxidation of hydrogen chloride to chlorine is an equilibrium reaction. The position of the equilibrium shifts to the disfavour of the desired end product as the temperature increases. It is therefore advantageous to employ catalysts with the highest possible activity, which allow the reaction to proceed at a low temperature.

The first catalysts for oxidation of hydrogen chloride contained copper chloride or oxide as the active component and were already described by Deacon in 1868. However, these had only low activities at a low temperature (<400° C.). By increasing the reaction temperature, it was indeed possible to increase the activity, but a disadvantage was that the volatility of the active components at higher temperatures led to a rapid decrease in the activity of the catalyst.

The oxidation of hydrogen chloride with catalysts based on chromium oxides has been described. However, the process realized by such means has an inadequate activity and high reaction temperatures.

First catalysts for the oxidation of hydrogen chloride containing the catalytically active component ruthenium were described in 1965. Such catalysts were, starting from RuCl₃ for example, supported on silicon dioxide and aluminium oxide. However, the activity of these RuCl₃/SiO₂ catalysts is very low. Further Ru-based catalysts with the active mass of ruthenium oxide or ruthenium mixed oxide and various oxides, such as e.g., titanium dioxide, zirconium dioxide etc., as the support material have also been described. In such catalysts, the content of ruthenium oxide is generally 0.1 wt. % to 20 wt. % and the average particle diameter of ruthenium oxide is 1.0 nm to 10.0 nm. Further Ru catalysts supported on titanium dioxide or zirconium dioxide are known. A number of Ru starting compounds, such as e.g., ruthenium-carbonyl complexes, ruthenium salts of inorganic acids, ruthenium-nitrosyl complexes, ruthenium-amine complexes, ruthenium complexes of organic amines or ruthenium-acetylacetonate complexes, have been described for the preparation of the ruthenium chloride and ruthenium oxide catalysts described which contain at least one compound of titanium oxide and zirconium oxide. In a described embodiment, TiO₂ in the rutile form was employed as the support. The ruthenium oxide catalysts have a quite high activity, but the use thereof is expensive and requires a number of operations, such as precipitation, impregnation with subsequent precipitation etc., scale-up of which is difficult industrially. In addition, at high temperatures Ru oxide catalysts also tend towards sintering and thus towards deactivation.

EP 0936184 A2 describes a process for the catalytic oxidation of hydrogen chloride, wherein the catalyst is chosen from an extensive list of possible catalysts. Among the catalysts is the variant designated number (6), which comprises the active component (A) and a component (B). Component (B) is a compound component which has a certain thermal conductivity. Tin dioxide, inter alia, is mentioned as an example. In addition, component (A) can be absorbed on to a support. However, possible supports do not include tin dioxide. There is also not a single example in which tin dioxide was used. Furthermore, exclusively the use of ruthenium oxide as a catalyst component is described in this patent. This is prepared, in particular, by impregnation of the support with a ruthenium chloride solution, precipitation of the ruthenium hydroxide on the support and subsequent calcining. The document mentioned consequently discloses neither the use of tin dioxide as a catalyst support in the catalytic gas phase oxidation of hydrogen chloride with oxygen, nor the use of a halogen-containing ruthenium compound as a catalyst component.

The catalysts developed to date for the Deacon process have a number of inadequacies. At low temperatures, the activity thereof is inadequate. It was indeed possible to increase the activity by increasing the reaction temperature, but this led to sintering/deactivation or to a Loss in the catalytic component.

### SUMMARY OF THE INVENTION

One object of the present invention is to provide a catalytic system which effects the oxidation of hydrogen chloride at low temperatures and with high activities. This object can be achieved by the development of a combination of catalytically active components and a specific support material.

It has surprisingly been found that targeted supporting of a halogen-containing ruthenium compound on tin dioxide provides novel highly active catalysts which have a high catalytic activity in the oxidation of hydrogen chloride, especially at temperatures of ±350° C. While not wishing to be bound by any particular theory, it is believed that the particular interaction between catalytically active component and support provides such high activity at low temperatures. A further advantage of the catalyst system according to the invention is the simple application, which is easy to scale up, of the catalytically active component to the support. Furthermore, a conversion of the catalytically active halogen-containing species into the oxide is unnecessary.

One embodiment of the present invention includes a process comprising: reacting hydrogen chloride with oxygen in a gas phase oxidation in the presence of a catalyst, said catalyst comprising tin dioxide and a halogen-containing ruthenium compound.

Another embodiment of the present invention includes a composition comprising tin dioxide and a halogen-containing ruthenium compound. A preferred embodiment of the present invention includes a catalyst for gas phase oxidation of hydrogen chloride comprising a halogen-containing ruthenium compound on a tin dioxide support material.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there is shown in the drawing an embodiment which is presently preferred. It should be understood, however, that the invention is not limited to the precise arrangements and instrumentalities shown.

In the Figs.:

FIG. 1 is a graph of chlorine formation over time using a catalyst according to an embodiment of the present invention;

FIG. 2 is a scanning electron microscopy photograph of an extrudate impregnated with ruthenium in accordance with an embodiment of the present invention;

FIG. 3 is a graph of tin distribution in the extrudate of FIG. 2; and

FIG. 4 is a graph of ruthenium distribution in the extrudate of FIG. 2.

### DETAILED DESCRIPTION OF THE INVENTION

As used herein, the singular terms “a” and “the” are synonymous and used interchangeably with “one or more.” Accordingly, for example, reference to “a compound” herein or in the appended claims can refer to a single compound or more than one compound. Additionally, all numerical values, unless otherwise specifically noted, are understood to be modified by the word “about.”

The present invention relates to a process for the preparation of chlorine by catalytic gas phase oxidation of hydrogen chloride with oxygen, wherein the catalyst comprises tin dioxide and at least one halogen-containing ruthenium compound.

In a preferred embodiment, tin(IV) oxide is employed as the support for the catalytically active component, particularly preferably tin dioxide in the rutile structure.

According to the invention, a halogen-containing ruthenium compound is used as the catalytically active component. This is a compound in which a halogen is bonded in ionic to polarized covalent form to a ruthenium atom.

The halogen in the halogen-containing ruthenium compound is preferably chosen from the group which consists of chlorine, bromine and iodine. Chlorine is preferred.

Suitable halogen-containing ruthenium compounds include those which consist exclusively of halogen and ruthenium. However, those which contain both oxygen and halogen, in particular chlorine or chloride, are preferred. At least one ruthenium oxychloride compound is particularly preferably used as the catalytically active species. A ruthenium oxychloride compound in the context of the invention is a compound in which both oxygen and chlorine are present bonded in ionic to polarized covalent form to ruthenium. Such a compound thus has the general composition RuOₓCl_{y}. According to the invention, various such ruthenium oxychloride compounds can be present side-by-side in the catalyst. Examples of defined ruthenium oxychloride compounds include, in particular, the following compositions: Ru₂OCl₄, RuOCl₂, Ru₂OCl₅ and Ru₂OCl₆.

In certain particularly preferred embodiments of processes according to the invention, the halogen-containing ruthenium compound comprises a mixed compound corresponding to the general formula RuClₓO_{y}, wherein x denotes a number of 0.8 to 1.5 and y denotes a number of 0.7 to 1.6.

The catalytically active ruthenium oxychloride compound in the context of the invention is preferably obtainable by a process which comprises initially the application of an aqueous solution or suspension of at least one halogen-containing ruthenium compound to tin dioxide and removal of solvent.

Other examples of conceivable processes include the chlorination of ruthenium compounds which do not contain chlorine, such as ruthenium hydroxides, before or after absorption on to the support.

One preferred process embodiment includes the application of an aqueous solution of RuCl₃ to the tin dioxide.

The application includes, in particular, impregnation of the optionally freshly precipitated tin dioxide with the solution of the halogen-containing ruthenium compound.

After the application of the halogen-containing ruthenium compound, a drying step which is expediently carried out in the presence of oxygen or air generally takes place, in order to render possible at least in part a conversion into the preferred ruthenium oxychloride compounds. In order to avoid a conversion of the preferred ruthenium oxychloride compounds into ruthenium oxides, the drying should preferably be carried out at below 280° C., in particular at no less than 80° C., particularly preferably 100° C.

A preferred embodiment of a process according to the invention is characterized in that the catalyst is obtainable by a process in which a tin dioxide support loaded with a halogen-containing ruthenium compound is calcined at a temperature of at least 200° C., preferably at least 220° C., particularly preferably at least 250° C. to 500° C., in particular in an oxygen-containing atmosphere, particularly preferably under air.

In a particularly preferred process, the content of ruthenium from the halogen-containing ruthenium compound in relation to the total catalyst composition, in particular after the calcining, is 0.5 to 5 wt. %, preferably 1.0 to 3 wt. %, particularly preferably 1.5 to 3 wt. %.

If halogen-ruthenium compounds which contain no oxygen are to be absorbed as the catalytically active species, drying can also be carried out at higher temperatures with exclusion of oxygen.

The substantial conversion of the halogen-ruthenium compound into the preferred ruthenium oxyhalogen compounds is preferably carried out in the reactor under the conditions of the oxidation process. The evaluation of the interplanar spacings in the HR-TEM (high resolution transmission electron microscopy) of a ruthenium chloride-SnO₂ catalyst thus shows that this is converted into ruthenium oxychloride under the conditions of the gas phase oxidation of hydrogen chloride.

Preferably, the catalyst is obtainable by a process which comprises the application of an aqueous solution or suspension of at least one halogen-containing ruthenium compound to tin dioxide and subsequent drying at below 280° C., and subsequent activation under the conditions of the gas phase oxidation of hydrogen, during which substantial conversion into the ruthenium oxychlorides takes place. The longer the drying in the presence of oxygen takes place, the more oxychloride formed.

The loading of the catalytically active component, i.e., the halogen-containing ruthenium compound, is generally in the range of 0.1-80 wt. %, preferably in the range of 1-50 wt. %, particularly preferably in the range of 1-20 wt. %, based on the total weight of the catalyst (catalyst component and support).

Particularly preferably, the catalytic component, i.e., the halogen-containing ruthenium compound, can be applied to the support, for example, by moist and wet impregnation of a support with suitable starting compounds present in solution or starting compounds in liquid or colloidal form, precipitation and co-precipitation processes, and ion exchange and gas phase coating (CVD, PVD).

Promoters may be used. Possible promoters are metals which have a basic action (e.g., alkali, alkaline earth and rare earth metals). Alkali metals, in particular Na and Cs, and alkaline earth metals are preferred, and alkaline earth metals, in particular Sr and Ba, are particularly preferred.

The promoters can be applied to the catalyst by impregnation and CVD processes, without being limited thereto, and an impregnation is preferred, particularly preferably after application of the catalytic main component.

For stabilization of the dispersion of the catalytic main component on the support, various dispersion stabilizers, such as, for example, scandium oxides, manganese oxides and lanthanum oxides etc., can be employed, for example, without being limited thereto. The stabilizers are preferably applied by impregnation and/or precipitation together with the catalytic main component.

The tin dioxide used according to the invention is commercially obtainable (e.g., from Chempur, Alfa Aesar) or obtainable, for example, by alkaline precipitation of tin(IV) chloride and subsequent drying. It has, in particular, BET surface areas of from about 1 to 300 m²/g.

The tin dioxide used as the support according to the invention can undergo a reduction in the specific surface area under exposure to heat (such as at temperatures of more than 250° C.), which can be accompanied by a reduction in the activity of the catalyst. The pretreatment of the SnO₂ support can be carried out by a calcining, for example at 250-1,500° C., but very preferably at 300-1,200° C. The above-mentioned dispersion stabilizers can also serve to stabilize the surface of the tin dioxide at high temperatures.

A further preferred process is in fact characterized in that the reaction temperature during the catalytic gas phase oxidation is up to 450° C., preferably not more than 420° C.

The catalysts can be dried under normal pressure or, preferably, under reduced pressure, preferably at 40 to 200° C. The duration of the drying is preferably 10 min to 6 h.

The catalysts according to the invention for the oxidation of hydrogen chloride are distinguished by a high activity at low temperatures.

Preferably, as already described above, the novel catalyst composition is employed in the catalytic processes known as the Deacon process. In this, hydrogen chloride is oxidized with oxygen in an exothermic equilibrium reaction to give chlorine, water vapour being obtained. The reaction temperature is conventionally 180 to 500° C., particularly preferably 200 to 400° C., especially preferably 220 to 350° C., and the conventional reaction pressure is 1 to 25 bar, preferably 1.2 to 20 bar, particularly preferably 1.5 to 17 bar, very particularly preferably 2 to 15 bar. Since it is an equilibrium reaction, it is expedient to work at the lowest possible temperatures at which the catalyst still has a sufficient activity. It is furthermore expedient to employ oxygen in amounts in excess of the stoichiometric amounts with respect to hydrogen chloride. For example, a two- to four-fold oxygen excess is conventional. Since no losses in selectivity are to be feared, it may be economically advantageous to operate under a relatively high pressure and accordingly with a longer dwell time compared with normal pressure.

Suitable preferred catalysts for the Deacon process which can be combined with the novel catalyst support comprise ruthenium oxide, ruthenium chloride or other ruthenium compounds on silicon dioxide, aluminium oxide, titanium dioxide or zirconium dioxide as the support.

Suitable catalysts, in addition to the ruthenium compound, can also be compounds of other noble metals, for example gold, palladium, platinum, osmium, iridium, silver, copper or rhenium. Suitable catalysts can furthermore comprise chromium oxide.

The catalytic oxidation of hydrogen chloride can preferably be carried out adiabatically or isothermally or approximately isothermally, discontinuously, but preferably continuously, as a fluidized or fixed bed process, preferably as a fixed bed process, particularly preferably in tube bundle reactors over heterogeneous catalysts at a reactor temperature of from 180 to 500° C., preferably 200 to 400° C., particularly preferably 220 to 350° C., under a pressure of from 1 to 25 bar (1,000 to 25,000 hPa), preferably 1.2 to 20 bar, particularly preferably 1.5 to 17 bar and especially preferably 2.0 to 15 bar.

Conventional reaction apparatuses in which the catalytic oxidation of hydrogen chloride is carried out are fixed bed or fluidized bed reactors. The catalytic oxidation of hydrogen chloride can also preferably be carried out in several stages.

In the adiabatic and the isothermal or approximately isothermal procedure, several, that is to say 2 to 10, preferably 2 to 6, particularly preferably 2 to 5, in particular 2 to 3 reactors connected in series with intermediate cooling can be employed. The oxygen either can all be added together with the hydrogen chloride before the first reactor, or can be distributed over the various reactors. This connection of individual reactors in series can also be combined in one apparatus.

A further preferred embodiment of a device which is suitable for the process comprises employing a structured packed catalyst in which the catalyst activity increases in the direction of flow. Such a structuring of the packed catalyst can be effected by different impregnation of the catalyst support with active mass or by different dilution of the catalyst with an inert material. Rings, cylinders or balls of tin dioxide, titanium dioxide, zirconium dioxide or mixtures thereof, aluminium oxide, steatite, ceramic, glass, graphite or high-grade steel can be employed, for example, as inert material. In the preferred use of catalyst shaped bodies, the inert material should preferably have similar external dimensions.

Suitable catalyst shaped bodies are shaped bodies of any desired shapes;

tablets, rings, cylinders, stars, wagon wheels or balls are preferred, and rings, cylinders, balls or star strands are particularly preferred as the shape. The ball shape is preferred. The size of the catalyst shaped bodies, e.g. diameter in the case of balls or maximum cross-sectional width, is on average in particular 0.3 to 7 mm, very preferably 0.8 to 5 mm.

Alternatively to the finely divided catalyst (shaped) bodies described above, the support can also be a monolith of support material, e.g. not only a “classic” support body with parallel channels not connected radially to one another; monoliths also include foams, sponges or the like having three-dimensional connections within the support body, as well as support bodies with cross-flow channels.

The monolithic support can have a honeycomb structure, and also an open or closed cross-channel structure. The monolithic support has a preferred cell density of from 100 to 900 cpsi (cells per square inch), particularly preferably from 200 to 600 cpsi.

A monolith in the context of the present invention is disclosed e.g. in “Monoliths in multiphase catalytic processes—aspects and prospects” by F. Kapteijn, J. J.

Heiszwolf T. A. Nijhuis and J. A. Moulijn, Cattech 3, 1999, p. 24.

Suitable additional support materials or binders for the support are in particular, for example, silicon dioxide, graphite, titanium dioxide having the rutile or anatase structure, zirconium dioxide, aluminium oxide or mixtures thereof, preferably titanium dioxide, zirconium dioxide, aluminium oxide or mixtures thereof, particularly preferably γ- or δ-aluminium oxide or mixtures thereof. Aluminium oxide or zirconium oxide is the preferred binder. The content of binder can be, based on the finished catalyst, 1 to 70 wt. %, preferably 2 to 50 wt. % and very preferably 5 to 30 wt. %. The binder increases the mechanical stability (strength) of the catalyst shaped bodies.

In a particularly preferred variant of the invention, the catalytically active component is substantially present on the surface of the actual support material, e.g. of the tin oxide, but not on the surface of the binder.

For additional doping of the catalysts, alkali metals, such as lithium, sodium, potassium, rubidium and caesium, preferably lithium, sodium and potassium, particularly preferably potassium, alkaline earth metals, such as magnesium, calcium, strontium and barium, preferably magnesium and calcium, particularly preferably magnesium, rare earth metals, such as scandium, yttrium, lanthanum, cerium, praseodymium and neodymium, preferably scandium, yttrium, lanthanum and cerium, particularly preferably lanthanum and cerium, or mixtures thereof are suitable as promoters.

The conversion of hydrogen chloride in a single pass can preferably be limited to 15 to 90%, preferably 40 to 85%, particularly preferably 50 to 70%. Some or all of the unreacted hydrogen chloride, after being separated off, can be recycled into the catalytic oxidation of hydrogen chloride. The volume ratio of hydrogen chloride to oxygen at the reactor intake is preferably 1:1 to 20:1, preferably 2:1 to 8:1, particularly preferably 2:1 to 5:1.

The heat of reaction of the catalytic oxidation of hydrogen chloride can be utilized in an advantageous manner for generating high pressure steam. This can be utilized for operation of a phosgenation reactor and/or of distillation columns, in particular of isocyanate distillation columns.

In a further step, the chlorine formed is separated off. The separating off step conventionally comprises several stages, namely separating off and optionally recycling of unreacted hydrogen chloride from the product gas stream of the catalytic oxidation of hydrogen chloride, drying of the stream obtained, comprising substantially chlorine and oxygen, and separating off of chlorine from the dried stream.

Unreacted hydrogen chloride and the water vapour formed can be separated off by condensing aqueous hydrochloric acid out of the product gas stream of the hydrogen chloride oxidation by cooling. Hydrogen chloride can also be absorbed in dilute hydrochloric acid or water.

The invention furthermore provides the use of tin dioxide as a catalyst support for a catalyst in the catalytic gas phase oxidation of hydrogen chloride with oxygen.

The invention also provides a catalyst composition which comprises tin dioxide and at least one halogen-containing ruthenium compound.

A composition which is characterized in that the halogen is chosen from the series: chlorine, bromine and iodine is preferred.

The halogen-containing ruthenium compound particularly preferably comprises a ruthenium oxychloride compound.

The halogen-containing ruthenium compound is very particularly preferably a mixed compound corresponding to the general formula RuClₓO_{y}, wherein x denotes a number from 0.8 to 1.5 and y denotes a number from 0.7 to 1.6.

The catalyst composition is preferably obtainable by a process which comprises the application of an in particular aqueous solution or suspension of at least one halogen-containing ruthenium compound to tin dioxide and the removal of the solvent.

The halogen-containing ruthenium compound here is particularly preferably RuCl₃.

The catalyst composition is obtainable in particular by a process which comprises the application of an aqueous solution or suspension of at least one halogen-containing ruthenium compound to tin dioxide and the subsequent drying at not less than 80 ° C., preferably not less than 100° C.

The catalyst composition is particularly preferably obtainable by a process in which a tin dioxide support loaded with a halogen-containing ruthenium compound is calcined at a temperature of at least 200° C., preferably at least 240° C., particularly preferably at least 270° C. to 500° C., in particular in an oxygen-containing atmosphere, particularly preferably under air.

The content of the halogen-containing ruthenium compound in relation to the total catalyst composition, in particular after the calcining, is 0.5 to 5 wt. %, preferably 1.0 to 3 wt. %.

The invention also provides the use of the catalyst composition as a catalyst, in particular for oxidation reactions, particularly preferably as a catalyst in the catalytic gas phase oxidation of hydrogen chloride with oxygen.

The following examples are for reference and do not limit the invention described herein.

### EXAMPLES

### Example 1 (Invention)

### Supporting of Ruthenium Chloride on SnO₂

20 g of commercially available tin(IV) oxide (Chempur; with a BET surface area of 4.4 m²/g) were suspended in a solution of 2.35 g of commercially obtainable ruthenium chloride n-hydrate in 50 ml of water in a round-bottomed flask with a dropping funnel and reflux condenser and the mixture was stirred for 180 min at room temperature and then for 120 min at 65° C. The excess solution was filtered off and the moist solid was dried at 120° C. in a vacuum drying cabinet for 4 h, and in each case 5 g were then dried for 3 h at 250° C. in a stream of air, a ruthenium chloride catalyst supported on tin(IV) oxide being obtained. The amount of Ru, determined by elemental analysis (ICP-OES), was 4.1 wt. %, that of Cl 1.1 wt. %.

### Example 2 (Invention)

20 g of commercially available tin(IV) oxide (Sigma-Aldrich; with a BET surface area of 15 m²/g) were suspended in a solution of 2.35 g of commercially obtainable ruthenium chloride n-hydrate in 50 ml of water in a round-bottomed flask with a dropping funnel and reflux condenser and the mixture was stirred for 60 min at room temperature. The water was then separated off in a stream of air at 60° C. The calcining was carried out for 16 h at 250° C. in a stream of air, a ruthenium chloride catalyst supported on tin(IV) oxide being obtained. The amount of Ru, determined by elemental analysis (ICP-OES), was 3.8 wt. %, that of Cl 1.6 wt. %.

### Example 3 (Comparison)

### Supporting Ruthenium Chloride on Silica Gel (SiO₂)

In accordance with the process in Example 1, a catalyst of ruthenium chloride on silicon dioxide (silica gel 100, Merck) was prepared and was calcined for 3 h at 250° C. in a stream of air. The amount of Ru, determined by elemental analysis (ICP-OES), was 4.1%, that of Cl 0.8 wt. %.

### Example 4 (Comparison)

### Supporting Ruthenium Oxide on TiO₂

20 g of support (titanium oxide; manufacturer Sachtleben; with a BET surface area of 90 m²/g) were suspended in a 1 l three-necked flask at room temperature and the suspension was stirred with a magnetic stirrer. 1.93 g of ruthenium chloride n-hydrate were dissolved in 50 ml of water and the solution was added to the suspension. The suspension was then stirred for 30 min. 24 g of 10% strength sodium hydroxide solution were then added dropwise in the course of 15 min and the mixture was stirred for a further 30 min. Thereafter, a further 12 g of 10% strength sodium hydroxide solution were added dropwise in the course of 10 min. The reaction mixture was then heated to 65° C., kept at this temperature for 1 h and cooled to 40° C., while stirring. Thereafter, the suspension was filtered and the solid was washed five times with 50 ml of water. The moist solid was dried at 120° C. in a vacuum drying cabinet for 4 h and then calcined in a muffle oven for 2 h at 300° C. The amount of Ru, determined by elemental analysis (ICP-OES), was 4.0 wt. %, that of Cl<0.2 wt. %.

### Example 5 (Reference)

### Blank Experiment with Tin Dioxide

As a blank experiment, tin dioxide was used instead of a catalyst and was tested as described below. The small amount of chlorine produced is to be attributed to the gas phase reaction.

### CATALYST TESTS

Use of the Catalysts in the Oxidation of HCl

A gas mixture of 80 ml/min (STP) of hydrogen chloride and 80 ml/min (STP) of oxygen flowed through the catalysts from Examples 1 to 5 in a packed fixed bed in a quartz reaction tube (internal diameter 10 mm) at 300° C. The quartz reaction tube was heated by an electrically heated fluidized bed of sand. After 30 min the product gas stream was passed into 16% strength potassium iodide solution for 10 min. The iodine formed was then back-titrated with 0.1 N thiosulfate standard solution in order to determine the amount of chlorine passed in. Table 1 shows the results.

TABLE 1
Activity in the oxidation of HCl

| | | Ru | Cl | Chlorine formation | Chlorine formation |
|---|---|---|---|---|---|
| Example | Composition | wt. % | wt. % | mmol/min · g (cat) | mmol/min · g (Ru) |
| 1 | RuCl₃/SnO₂ | 4.1 | 1.1 | 0.35 | 8.5 |
| 2 | RuCl₃/SnO₂ | 3.8 | 1.6 | 0.89 | 23.4 |
| 3 (ref.) | RuCl₃/SiO₂ | 4.1 | 0.8 | 0.15 | 3.8 |
| 4 (ref.) | RuO₂/TiO₂ | 4.0 | <0.2 | 0.55 | 13.7 |
| 5 (ref.) | SnO₂ | — | — | (0.08) | — |

Long-Term Study: Long-Term Stability of Catalyst Supported on Tin Oxide

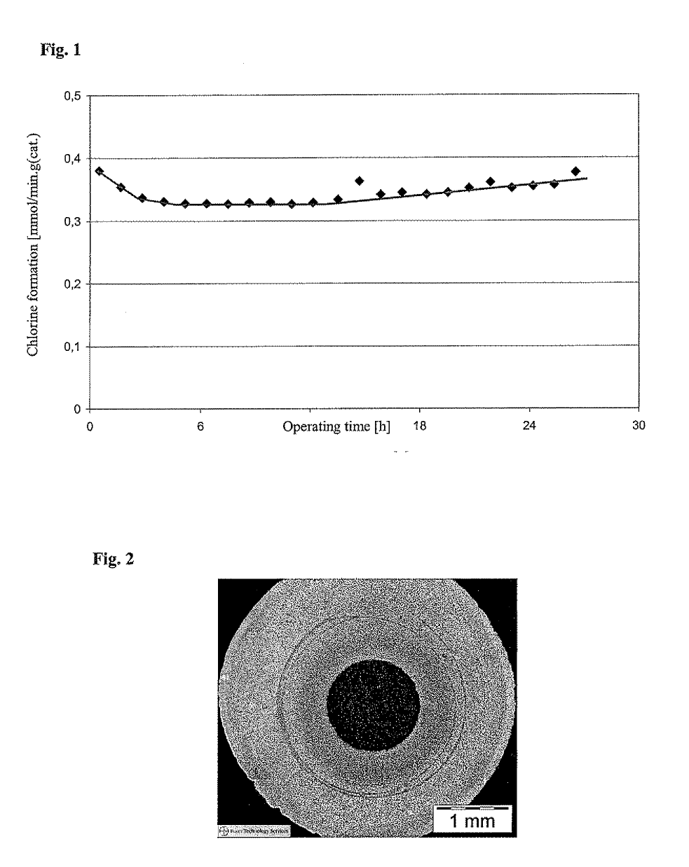

The catalyst from Example 1 was tested as described above, but the time of the experiment was lengthened and several samples were taken by passage into 16% strength potassium iodide solution for 10 minutes. The amounts of chlorine shown in FIG. 1 result.

### Example 6

4.994 g of commercially available ruthenium chloride n-hydrate were dissolved in 16.62 g of H₂O. 100 g of spherical SnO₂ shaped bodies with an average diameter of 1.9 mm, a BET of 45.1 m²/g and 15 wt. % of Al₂O₃ were added to the solution and the components were mixed thoroughly until the solution had been taken up completely by the support. After a standing time of 1 h, the solid was dried overnight in a stream of air at 60° C. The catalyst was then calcined for 16 h at 250° C. The amount of Ru, determined by elemental analysis (ICP-OES), was 1.9 wt. %, that of Cl 0.5 wt. %.

In an electron microscopy photograph/analysis (EDX), it was found that the catalytically active species (ruthenium oxychloride) is only on the tin oxide, but not on the surface of the aluminium oxide (binder).

### Catalyst Test Example 6

### Use of the Catalysts in the Oxidation of HCl

25 g of the catalyst from Example 6 were incorporated into an Ni fixed bed reactor (diameter 10 mm, length 800 mm) together with 75 g of non-coated support. A packed fixed bed of approx. 150 mm was thereby obtained. A gas mixture of 56 l/h (STP) of hydrogen chloride and 28 l/h (STP) of oxygen flowed through the packed fixed bed at 300° C. under a pressure of 4 bar. The Ni reactor was heated by means of a heat transfer medium. After 30 min the product gas stream was passed into 16% strength potassium iodide solution for 5 min. The iodine formed was then back-titrated with 0.1 N thiosulfate standard solution in order to determine the amount of chlorine passed in. The catalyst activity calculated therefrom was 0.40 kg_{Cl2}/kg_{CAT}·h.

The addition of aluminium oxide as a binder furthermore evidently had the effect of a higher strength of the spherical catalyst than comparable shaped bodies which comprise merely tin oxide as the support material.

### Example 7

### Sn Coating

20 g of aluminium oxide shaped bodies (hollow extrudate, 4×9 mm, Sasol) were initially introduced into a conical flask cooled with ice-water and were covered with a layer of 93.34 g of SnCl₄ and left to stand for 30 min. The SnCl₄ was then decanted into a second conical flask. The shaped bodies were covered with a layer of 150 ml of water via a dropping funnel and left to stand for 30 min. The shaped bodies coated in this way were washed neutral with water and then dried to constant weight at 60° C./10 mbar in a drying cabinet (21.51 g). This operation was repeated once more. 5 g of the shaped bodies were then calcined for 4 h at 750° C. in a muffle oven.

### Example 8

### Ru Impregnation

0.078 g of ruthenium chloride n-hydrate (Heraeus) was dissolved in 0.39 ml of water, 2.5 g of the support prepared in Example 7 were added and the components were mixed until the solution had been taken up by the support. The impregnation time was 1.5 h. The moist solid was then dried at 60° C. in an oven (air) for approx. 5 h. The yield was 2.615 g. The ruthenium-containing catalyst prepared in this way was finally calcined for 16 h at 250° C. in a muffle oven. The ruthenium content was 1.1 wt. %, based on the catalyst material.

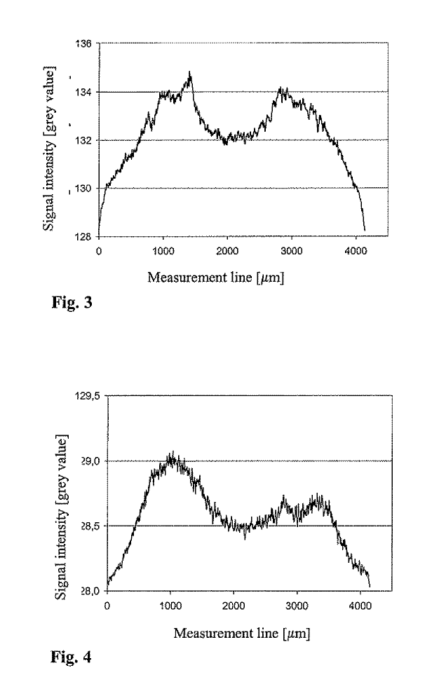

FIG. 2 shows a scanning electron microscopy photograph of the extrudate cross-section. FIG. 3 and FIG. 4 show the distribution of tin and, respectively, ruthenium in this section. Taking in to consideration the support-free sections of the image, the uniform distribution of the ruthenium in the support extrudate can be seen.

### Catalyst Test Example 8

### Use of the Catalysts in the Oxidation of HCl

A gas mixture of 80 ml/min (STP) of hydrogen chloride and 80 ml/min (STP) of oxygen flowed through the catalyst from Example 8 in a packed fixed bed in a quartz reaction tube (diameter 10 mm) at 300° C. The quartz reaction tube was heated by an electrically heated fluidized bed of sand. After 30 min the product gas stream was passed into 16% strength potassium iodide solution for 10 min. The iodine formed was then back-titrated with 0.1 N thiosulfate standard solution in order to determine the amount of chlorine passed in. A space/time yield of 1.46 kg_{Cl2}/kg_{cat}·h resulted.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising: reacting hydrogen chloride with oxygen in a gas phase oxidation in the presence of a catalyst, said catalyst comprising tin dioxide and a halogen-containing ruthenium compound.

2. The process according to claim 1, wherein the halogen-containing ruthenium compound comprises a halide selected from the group consisting of chlorine, bromine, iodine, and mixtures thereof.

3. The process according to claim 1, wherein the halogen-containing ruthenium compound comprises a ruthenium oxychloride compound.

4. The process according to claim 1, wherein the halogen-containing ruthenium compound comprises a compound corresponding to the general formula RuClₓO_{y}, wherein x represents a number of 0.8 to 1.5 and y represents a number of 0.7 to 1.6.

5. The process according to claim 1, wherein the catalyst is prepared by a process comprising applying an aqueous composition of the halogen-containing ruthenium compound to tin dioxide.

6. The process according to claim 5, wherein the halogen-containing ruthenium compound comprises RuCl₃.

7. The process according to claim 5, wherein the catalyst is prepared by the process further comprising drying the catalyst at a temperature not less than 80° C.

8. The process according to claim 5, wherein the catalyst is prepared by the process further comprising drying the catalyst at a temperature not less than 100° C.

9. The process according to claim 5, wherein the catalyst is prepared by the process further comprising calcining the catalyst on the tin oxide at a temperature of at least 200° C. in an oxygen-containing atmosphere.

10. The process according to claim 9, wherein ruthenium is present in an amount of 0.5 to 5 wt. % subsequent to calcining, based on the catalyst.

11. The process according to claim 1, wherein the gas phase oxidation is carried out at a reaction temperature of 180 to 500° C.

12. The process according to claim 2, wherein the gas phase oxidation is carried out under a pressure of 1 to 25 bar.

13. The process according to claim 3, wherein the gas phase oxidation is carried out adiabatically.

14. The process according to claim 1, wherein the tin dioxide comprises rutile tin dioxide.

15. A composition comprising tin dioxide and a halogen-containing ruthenium compound.

16. The composition according to claim 15, wherein the halogen-containing ruthenium compound comprises a halide selected from the group consisting of chlorine, bromine, iodine, and mixtures thereof.

17. The composition according to claim 15, wherein the halogen-containing ruthenium compound comprises a ruthenium oxychloride compound.

18. The composition according to claim 15, wherein the halogen-containing ruthenium compound comprises a compound corresponding to the general formula RuClₓO_{y}, wherein x represents a number of 0.8 to 1.5 and y represents a number of 0.7 to 1.6

19. The composition according to claim 15, prepared by a process comprising applying an aqueous composition of the halogen-containing ruthenium compound to tin dioxide.

20. The composition according to claim 19, wherein the aqueous composition comprises an aqueous solution of RuCl₃.

21. The composition according to claim 19, prepared by the process further comprising drying the catalyst at a temperature not less than 80° C.

22. The composition according to claim 19, wherein the catalyst is prepared by the process further comprising drying the catalyst at a temperature not less than 100° C.

23. The composition according to claim 19, wherein the catalyst is prepared by the process further comprising calcining the catalyst on the tin oxide at a temperature of at least 200° C. in an oxygen-containing atmosphere.

24. The composition according to claim 23, wherein ruthenium is present in an amount of 1 to 5 wt. % subsequent to calcining, based on the catalyst.
